(19) United States
(12) Patent Application Publication
(10) Pub. No.: US 2004/0024637 A1
(43) Pub. Date: Feb. 5, 2004

(54) System for providing horticultural based informational cards

(76) Inventor: Mac Faulkner, Montgomery, AL (US)

Correspondence Address: PRICE HENEVELD COOPER DEWITT & LITTON, 695 KENMOOR, S.E., P O BOX 2567, GRAND RAPIDS, MI, 49501, US

(21) Appl. No.: 10/209,022

(22) Filed: Jul. 31, 2002

(51) Int. Cl. G06F 17/60

(52) U.S. Cl. 705/14

(57) ABSTRACT

A computerized system for creating customized product display cards includes a customer accessible computer system, a vendor computer system and a printing system. The vendor computer system is in communication with the customer accessible computer system and electronically receives input from a customer, via the customer accessible computer system. The printing system is coupled to the vendor computer system and provides at least one customized display card whose content is based on the input from the customer.

### CROSS-REFERENCE TO RELATED APPLICATION

This application is related to U.S. patent application Ser. No. 10/057,265, entitled “CARTON LABELING SYSTEM AND PROCESS” to William J. Stehouwer et al., filed Jan. 25, 2002, the entire disclosure which is hereby incorporated herein by reference.

### BACKGROUND OF THE INVENTION

The present invention is generally directed to a computerized system and, more specifically, to a computerized system for creating customized product display cards.

Traditionally, customers have ordered display cards, such as horticultural product display cards, directly from the manufacturer, via, for example, telephone and/or by mail.

With respect to the horticultural environment, a customer, i.e., a garden center or other store, may desire to order a variety of horticultural product display cards with customized text and/or including a logo of the customer. In general, a manufacturer which supplies such display cards has required the customer to order a minimum number of cards, e.g., 250 of each card, in order to justify the cost of customizing the display card. In dealing with smaller customers, high minimum order requirements set by a manufacturer utilizing traditional printing presses has made customization of the display cards unaffordable for the vast majority of such customers.

Thus, what is needed is a system that allows a manufacturer to economically provide customized product display cards in lower minimum quantities.

### SUMMARY OF THE INVENTION

The present invention is generally directed to a computerized system for creating customized product display cards that includes a customer accessible computer system, a vendor computer system and a printing system. The vendor computer system is in communication with the customer accessible computer system and electronically receives input from a customer, via the customer accessible computer system. The printing system is coupled to the vendor computer system and provides at least one customized product display card, whose content is based on the input from the customer.

In one embodiment, the vendor computer system provides a menu to the customer accessible computer system that allows the customer to select at least one product image from a plurality of available product images for placement on the display card. According to another embodiment of the present invention, the vendor computer system provides a template to the customer accessible computer system that allows the customer to enter descriptive text for inclusion on the display card. In yet another embodiment, the plurality of available product images are pictures of horticultural products and the text includes at least one of a feature, a required sun exposure, a height and spread and an optimal planting site of a selected horticultural product.

These and other features, advantages and objects of the present invention will be further understood and appreciated by those skilled in the art by reference to the following specification, claims and appended drawings.

### BRIEF DESCRIPTION OF THE DRAWINGS

FIG. 1 is an electrical block diagram of an exemplary customer accessible computer system for facilitating communication with a vendor computer system, according to an embodiment of the present invention;

FIG. 2 is an electrical block diagram of an exemplary computer network, which can be utilized to create customized product display cards, according to an embodiment of the present invention;

FIG. 3 is a flowchart of a routine for creating customized product display cards, according to an embodiment of the present invention;

FIGS. 4A-4B are exemplary menus for a display card customization center, according to an embodiment of the present invention; and

FIGS. 5A-5B are exemplary display cards created according to an embodiment of the present invention.

### DETAILED DESCRIPTION OF THE PREFERRED EMBODIMENT(S)

According to an embodiment of the present invention, a computerized system for creating customized product display cards, e.g., FLORA-CARDS®, includes a customer accessible computer system, a vendor computer system, and a printing system. The vendor computer system is in communication with the customer accessible computer system and electronically receives input from a customer, via the customer accessible computer system. The printing system is coupled to the vendor computer system and provides at least one customized product display card, whose content is based on the input from the customer. The vendor computer system provides a menu to the customer accessible computer system that allows the customer to select at least one product image from a plurality of available product images for placement on the display card and may provide descriptive text for inclusion on the display card. In one embodiment, the plurality of available product images are pictures of horticultural products and the text includes at least one of a feature, a required sun exposure, a height and spread and an optimal planting site of a selected horticultural product. It is also contemplated that other textual information, e.g., a product price, can be included on the customized display card and that a customer may provide their own product images instead of selecting one provided by the manufacturer. In addition, the system may be configured to allow a customer to provide a customer logo for inclusion on the display card.

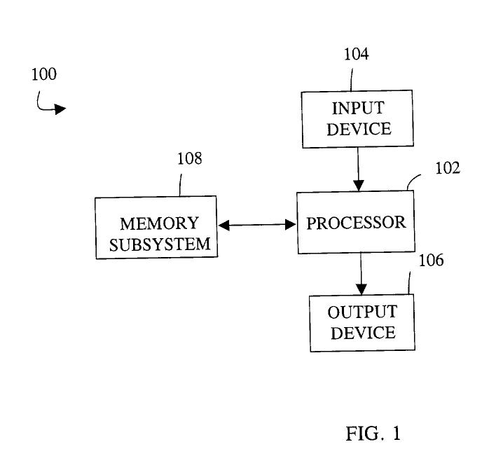

As is depicted in FIG. 1, an exemplary customer accessible computer system 100 includes a processor 102, an input device 104, an output device 106 and a memory subsystem 108. The input device 104, e.g., a keyboard and/or a mouse, is coupled to the processor 102 and allows the user of the device 104 to provide input to the computer system 100 and eventually to a vendor computer system, which is in communication with the system 100. The output device 106, e.g., a cathode ray tube (CRT) or liquid crystal display (LCD), is also coupled to the processor 102 and provides output, e.g., menus, forms, etc., to the customer. The memory subsystem 108 includes an application appropriate amount of volatile memory (e.g., a dynamic random access memory (DRAM)) and non-volatile memory (e.g., a flash memory, electrically erasable programmable read-only memory (EEPROM)) that store various code and information. The processor 102 performs a number of tasks as dictated by the processor executable code, which may be stored within an EEPROM or on a disk (not shown), e.g., a compact disk read-only memory (CD-ROM). The processor executable code causes the processor 102 to receive information from a user of the system 100 and provides a user's selection/entry to a vendor computer system, which in response to the input electronically received from the customer causes at least one customized display card to be printed on a printing system, e.g., a digital printer, coupled to the vendor computer system.

The system 100 is capable of receiving various information from a user of the system 100, via a graphical user interface, e.g., a menu and/or a template, provided to the user, via the customer accessible computer system 100. In this manner, the customer can select/provide at least one product image from a plurality of available product images for placement on the display card. Further, the template may also allow the customer to enter descriptive text for inclusion on the display card. The plurality of available product images may include pictures of horticultural products, such as flowers, trees and shrubs and the text may include at least one of a feature, a required sun exposure, a height and spread and an optimal planting site of a selected horticultural product. In addition, a customer can customize the text of a card to include other information, e.g., price, and may also provide customer logos for placement on the display card, if desired.

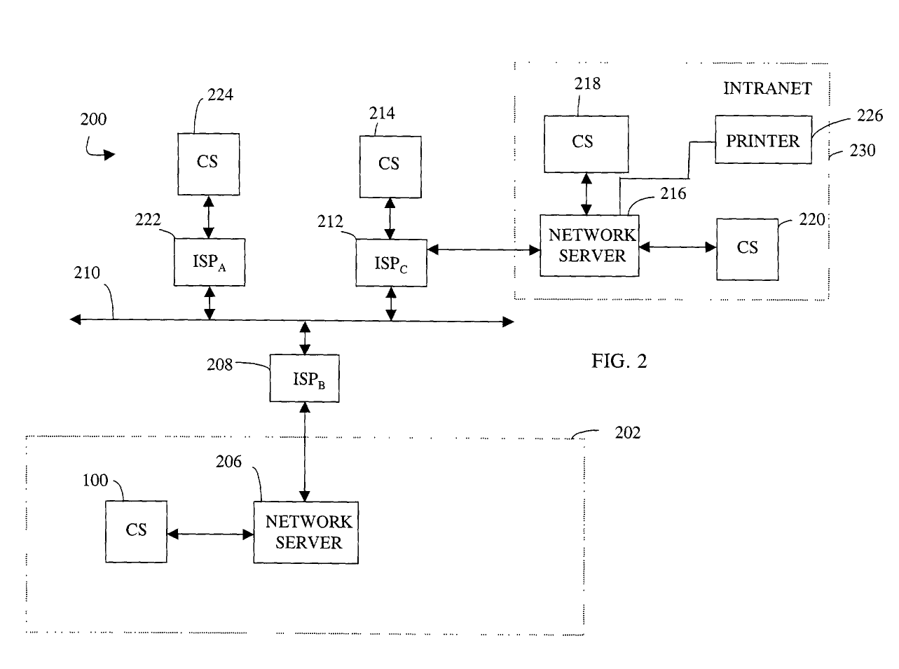

FIG. 2 depicts an exemplary computer network 200 that is capable of implementing the customization of a product display card, according to an embodiment of the present invention. The computer system 100, as described in conjunction with FIG. 1, is coupled to a customer network server 206 through, for example, a network interface card (NIC) and an Ethernet. In a typical application, the network server 206 is provided within a customer's premises and serves as an Internet server. In the disclosed embodiment, the network server 206 communicates, e.g., via a T1 line, with an internet service provider (ISPB) 208 that provides access to Internet 210. Also shown is a computer system 224, e.g., another customer computer system, that is coupled to the Internet 210 via ISPA 222. In this manner, a user utilizing computer system 224 or computer system 100 can communicate with a vendor computer system (e.g., a network server) 216, via an ISPC 212. The computer system 224 may be a personal computer (PC) that is coupled to the ISPA 222 via any number of communication links, e.g., a wireless connection, a dial-up connection, cable or a digital subscriber line (DSL) connection. In this alternative embodiment, a customer may complete the creation of a customized product display card from, for example, home, by communicating with the network server 216, via ISPA 222 and ISPC 212. The computer system 214, which is intended to represent another customer's computer system, is shown coupled to the network server 216, via ISPC 212. The network server 216 and computer systems 218 and 220 form an intranet 230 within, for example, a vendor's premises. The computer systems 214, 218, 220, 224 and 100 can be of a wide variety of types of computer systems, e.g., workstations or standard personal computers (PCs). According to the present invention, the network server 216 is coupled to a digital printer 226, which provides customized display cards for shipment to a customer based upon input received from the customer as described herein.

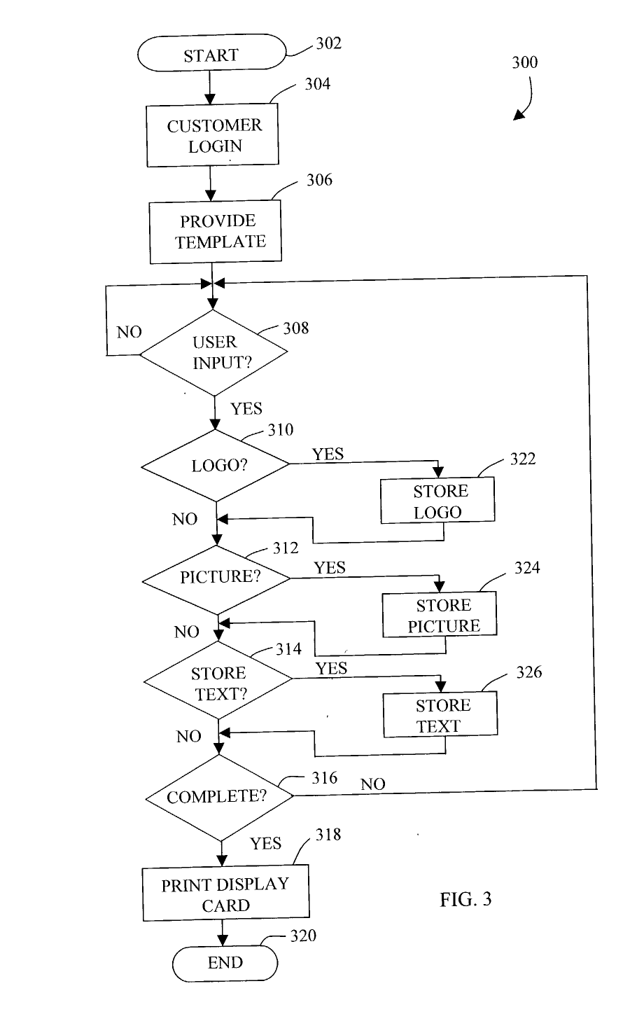

FIG. 3 is a flowchart of an exemplary display card customization routine 300 for creating a customized product display card, according to an embodiment of the present invention. As is shown, the routine 300 is initiated in step 302, at which point control transfers to step 304. In step 304, a customer establishes a communication link between a customer computer system, e.g., the system 100, and the network server 216, e.g., by entering an Internet address into the customer's browser, and logs into the server 216 establishing the customer's identity (name, billing address, etc.). Next, in step 306, the network server 216 provides a menu, e.g., a template, to the computer system 100 for utilization by the customer in facilitating the product display card customization and order finalization. Then, in decision step 308, the server 216 determines whether user input has been provided. If so, control transfers to decision step 310. Otherwise, control loops on step 308.

In step 310, the server 216 determines whether a user logo has been provided by the customer. If so, control transfers from step 310 to step 322, where the server 216 stores the logo at an appropriate location, at which point control transfers to decision step 312. If a logo has not been provided in step 310, control transfers to step 312 where the server 216 determines if the customer has provided a picture for use in creating the customized product display card or has selected one or more pictures available via the network server 216. When one or more pictures are selected in step 312, control transfers to step 324 where the server 216 stores the picture(s) in an appropriate location before control transfers to decision step 314. When a picture is not selected or provided in step 312, control transfers to step 314.

In step 314, the server 216 determines whether user provided text is received, and if so whether the received text should be stored or if default text or a combination of the two should be utilized. If so, control transfer from decision step 314 to step 326, where the server 216 initiates storage of default and/or customer supplied text in an appropriate location. Next, in decision step 316, the server 216 determines whether creation of the customized product display card is complete and if one or more cards should be printed. If so, control transfers from step 316 to step 318, where the server 216 initiates printing of the customized display card, at which point control transfers to step 320 where the routine 300 terminates. Otherwise, when the user has not indicated that the customization of the display card is complete, in step 316, control transfers to step 308 where card customization can continue.

Accordingly, a system has been described herein which allows a customer, via a customer accessible computer system, to access a vendor computer system and provide electronic input to the vendor system, which is also coupled to a printing system. Upon completion of a customer selection and an indication by the customer that the customer wishes to print the customized display cards, the network server provides appropriate files to a printing system such that a number of customized display cards, whose content is based on input from the customer, is printed.

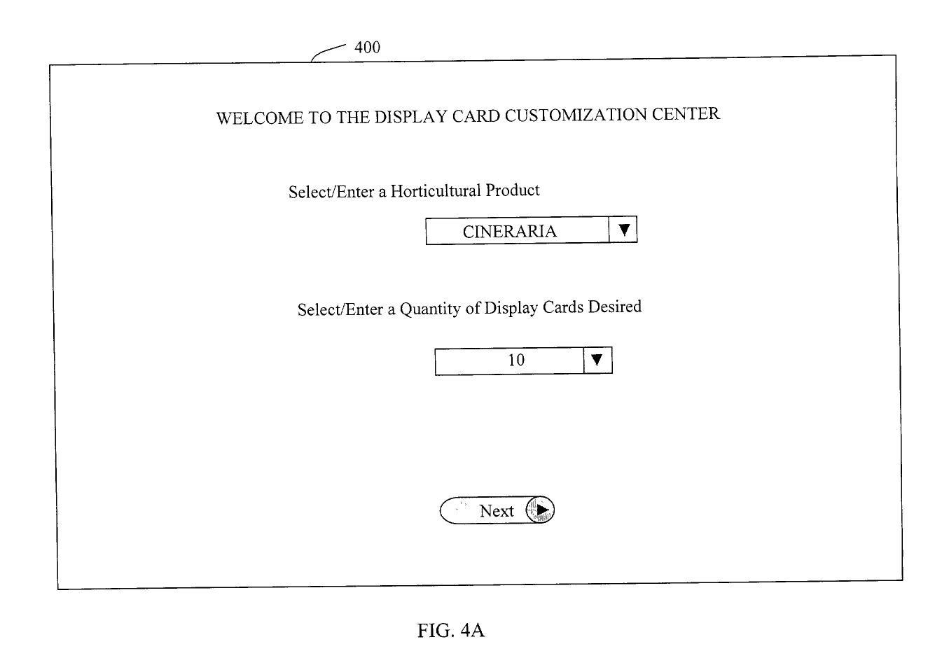

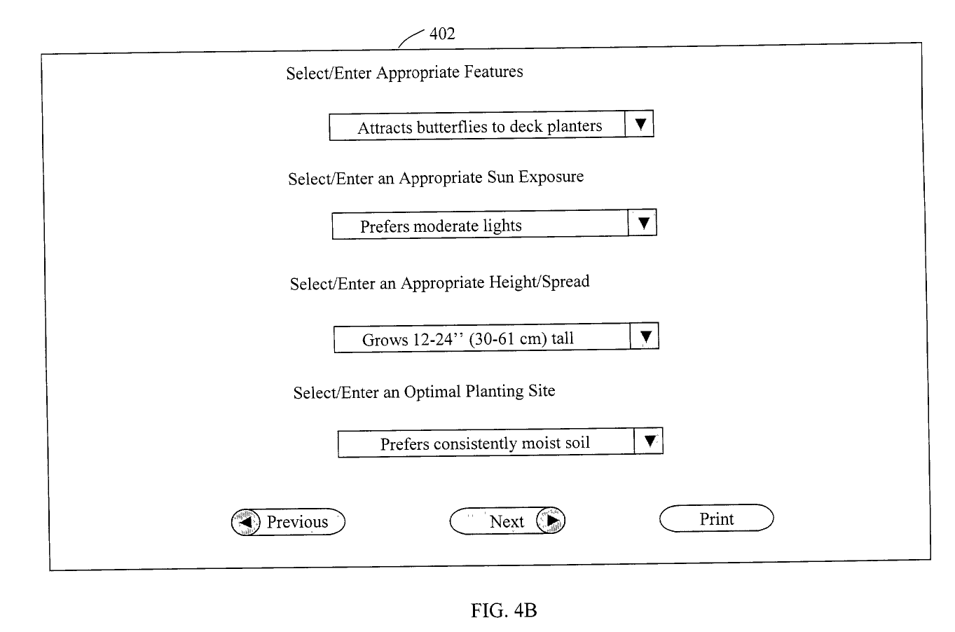

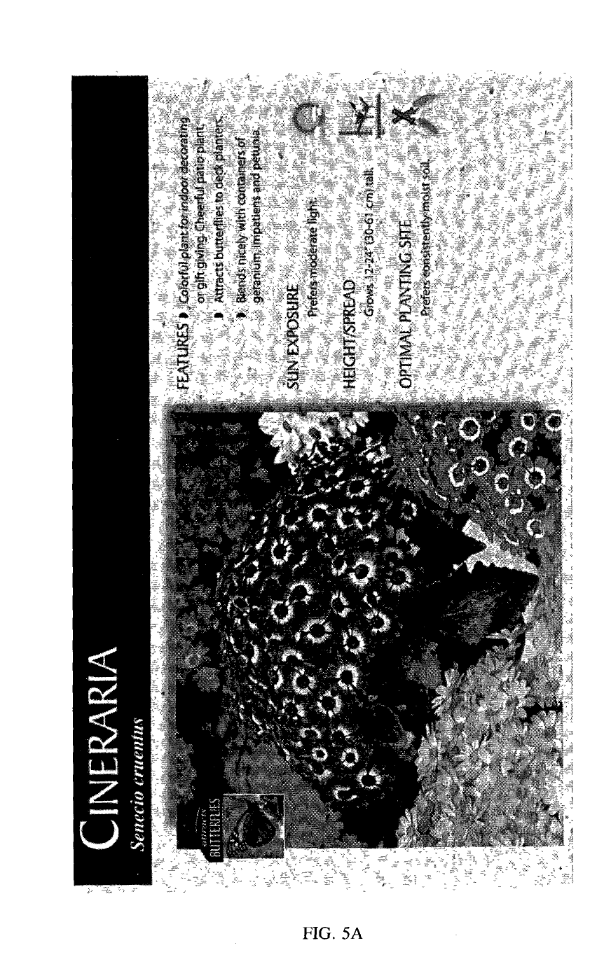

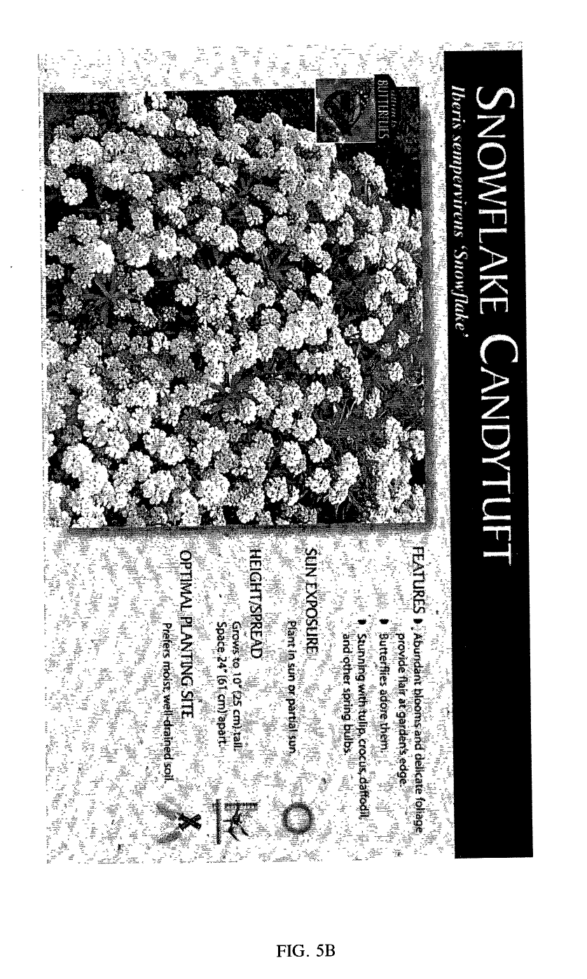

FIGS. 4A and 4B depict exemplary menus (e.g., templates) for utilization within a computerized system of the present invention. As is shown in FIG. 4A, a menu 400 is displayed which allows a user to select/enter a horticultural product and to select/enter a quantity of customized product display cards desired. Upon selecting a desired horticultural product (e.g., Cineraria) and a desired quantity, the user clicks on a next icon to go to menu 402, shown in FIG. 4B. As is shown on the menu 402, a customer can select/enter appropriate features, select/enter an appropriate sun exposure, select/enter an appropriate height and spread and select/enter an optimal planting site for the selected/entered horticultural product. It will be appreciated by one of ordinary skill in the art that other features can be added, such as price, etc. Upon entering the desired criteria, via the menus, a user may select a print icon from the window 402 to cause a number of customized product display cards (see FIGS. 5A-5B) to be printed.

The above description is considered that of the preferred embodiments only. Modification of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the Doctrine of Equivalents.

What is claimed is:

1. A computerized system for creating customized product display cards, comprising:
a customer accessible computer system;
a vendor computer system in communication with the customer accessible computer system, wherein the vendor computer system electronically receives input from a customer via the customer accessible computer system; and
a printing system coupled to the vendor computer system, wherein the printing system provides at least one customized product display card whose content is based on the input from the customer.

2. The system of claim 1, wherein the vendor computer system provides a template to the customer accessible computer system that allows the customer to select at least one product image from a plurality of available product images for placement on the display card.

3. The system of claim 2, wherein the vendor computer system provides a template to the customer accessible computer system that allows the customer to enter descriptive text for inclusion on the display card.

4. The system of claim 2, wherein the plurality of available product images are pictures of horticultural products.

5. The system of claim 3, wherein the plurality of available product images are pictures of horticultural products and the text includes at least one of a feature, a required sun exposure, a height and spread and an optimal planting site of a selected horticultural product.

6. The system of claim 1, wherein the printing system includes a digital printer.

7. The system of claim 1, wherein the vendor computer system provides a template to the customer accessible computer system that allows the customer to select at least one product image from a plurality of available product images for placement on the display card and provide descriptive text for inclusion on the display card, and wherein the plurality of available product images are pictures of horticultural products and the text includes at least one of a feature, a required sun exposure, a height and spread and an optimal planting site of a selected horticultural product.

8. A computerized system for creating customized horticultural product display cards, comprising:
a customer accessible computer system;
a vendor computer system in communication with the customer accessible computer system, wherein the vendor computer system electronically receives input from a customer via the customer accessible computer system; and
a printing system coupled to the vendor computer system, wherein the printing system provides at least one customized horticultural product display card whose content is based on the input from the customer.

9. The system of claim 8, wherein the vendor computer system provides a template to the customer accessible computer system that allows the customer to select at least one horticultural product image from a plurality of available horticultural product images for placement on the display card.

10. The system of claim 9, wherein the vendor computer system provides a template to the customer accessible computer system that allows the customer to enter descriptive text for inclusion on the horticultural display card.

11. The system of claim 9, wherein the plurality of available product images include multiple pictures for at least one of the horticultural products.

12. The system of claim 10, wherein the plurality of available product images are pictures of horticultural products and the text includes at least one of a feature, a required sun exposure, a height and spread and an optimal planting site of a selected horticultural product.

13. The system of claim 8, wherein the printing system includes a digital printer.

14. The system of claim 8, wherein the vendor computer system provides a template to the customer accessible computer system that allows the customer to select at least one product image from a plurality of available product images for placement on the display card and provide descriptive text for inclusion on the display card, and wherein the plurality of available product images are pictures of horticultural products and the text includes at least one of a feature, a required sun exposure, a height and spread and an optimal planting site of a selected horticultural product.

15. A computerized system for creating customized horticultural product display cards, comprising:
a customer accessible computer system;
a vendor computer system in communication with the customer accessible computer system, wherein the vendor computer system electronically receives input from a customer via the customer accessible computer system; and
a printing system coupled to the vendor computer system, wherein the printing system provides at least one customized horticultural product display card whose content is based on the input from the customer, and wherein the vendor computer system provides a template to the customer accessible computer system that allows the customer to select at least one product image from a plurality of available product images for placement on the display card and provide descriptive text for inclusion on the display card, where the plurality of available product images are pictures of horticultural products and the text includes at least one of a feature, a required sun exposure, a height and spread and an optimal planting site of a selected horticultural product.

16. The system of claim 15, wherein the printing system includes a digital printer.

17. A computerized system for creating customized product display cards, comprising:
a customer accessible computer system;
a vendor computer system in communication with the customer accessible computer system, wherein the vendor computer system electronically receives input from a customer via the customer accessible computer system; and
a printing system coupled to the vendor computer system, wherein the printing system provides at least one customized product display card whose content is based on the input from the customer, and wherein the vendor computer system provides a template to the customer accessible computer system that allows the customer to select/enter at least one product image from a plurality of available product images for placement on the display card.

18. The system of claim 17, wherein the vendor computer system provides a template to the customer accessible computer system that allows the customer to select/enter descriptive text for inclusion on the display card.

19. A computerized system for creating customized product display cards, comprising:
a customer accessible computer system;
a vendor computer system in communication with the customer accessible computer system, wherein the vendor computer system electronically receives input from a customer via the customer accessible computer system; and
a printing system coupled to the vendor computer system, wherein the printing system provides at least one customized product display card whose content is based on the input from the customer, and wherein the vendor computer system provides a template to the customer accessible computer system that allows the customer to select/enter descriptive text for inclusion on the display card.

20. The system of claim 19, wherein the vendor computer system provides a template to the customer accessible computer system that allows the customer to select/enter at least one product image from a plurality of available product images for placement on the display card.
